(19) United States
(12) Patent Application Publication
(10) Pub. No.: US 2003/0164157 A1
(43) Pub. Date: Sep. 4, 2003

(54) Injection valve for intake pipe or cylinder head with integrated fuel supply

(76) Inventor: Eckhard Bodenhausen, Steinheim (DE)

Correspondence Address: KENYON & KENYON, ONE BROADWAY, NEW YORK, NY, 10004, US

(21) Appl. No.: 10/240,508

(22) PCT Filed: Jan. 29, 2002
(86) PCT No.: PCT/DE02/00298

(30) Foreign Application Priority Data
Jan. 29, 2001 (DE) 101 03 826.7

(51) Int. Cl. F02M 1/00

(52) U.S. Cl. 123/470

(57) ABSTRACT

A device for supplying fuel to combustion chambers of an internal combustion engine is described. An injector (2), which is supplied with fuel through a fuel line (10), is accommodated in a receptacle (34) in the receiving body (1) of an internal combustion engine. The injector (2) is positioned in the receiving body (1) by using a hold down (9), the hold down (9) having areas (12, 18, 19) for receiving electric contact elements (13, 14, 16).

### TECHNICAL FIELD

Injectors for injecting fuel into the combustion chambers of internal combustion engines are either integrated into the cylinder head or inserted into the intake manifold of today's internal combustion engines. To ensure reliable functioning of the injectors, the individual injectors are acted upon by hold downs to secure them either in the intake manifold or in the cylinder head. The contact of the particular injector, with which the individual injectors of the engine are triggered cylinder by cylinder, is also accommodated in the cylinder head or intake manifold.

### BACKGROUND INFORMATION

German Patent Application 43 25 980 A1 relates to a device for joint electric contacting of a plurality of electrically energizable units of internal combustion engines. In the case of actuation of fuel injectors by electromagnetic means in particular, these have contact pins for the electric contact. A single circuit board having printed conductor is provided, running over all units and surrounded by a housing which protects the circuit board. The housing extends in the longitudinal direction of the circuit board and surrounds it at least partially. The individual units, i.e., injectors, are directly connected to the printed conductors of the circuit board via the contact pins.

German Patent 40 03 958 C2 relates to a contact strip for joint electric contacting of a plurality of electrically energizable units of internal combustion engines, in particular fuel injectors. First electrically conducting contact elements are provided in the contact strip and are each connectable by plug connectors to second electrically conducting contact elements of a unit. Each plug housing is held in the contact strip by a retaining element of the contact strip which projects into the particular plug housing so that it is floatingly movable in the horizontal and vertical directions with respect to the contact strip.

German Patent Application 41 18 512 A1 relates to an electrically operable fuel injector and a method of electrically contacting same. In the case of fuel injectors, which may be attached to a fuel distributor by rotation about the longitudinal axis of the injector, the first electric contact elements usually project out of the injector housing in parallel with the longitudinal axis of the injector. Such fuel injectors are electrically contactable by a contact strip, which may be placed on the fuel distributor in the direction of the longitudinal axis of the injector, but this takes up an especially great overall height. In the case of the proposed fuel injector, the first electric contact elements extend radially outward. By rotating the fuel injector about its longitudinal axis, an electrically conducting connection may be established between the first electric contact elements and the second electric contact elements contacting the fuel injector. This yields a simple, very compact and secure electric contacting of the fuel injectors. These may be used in particular for fuel injection systems of internal combustion engines having compression of a fuel-air mixture and spark ignition.

### ADVANTAGES OF THE INVENTION

With the implementation proposed according to the present invention, it is possible to achieve integration of a plurality of injectors situated one after the other in series into an intake manifold module or a cylinder head module. The fuel line for supplying the individual injectors is integrated into the intake manifold/cylinder head module. Each of the four, five, six or eight injectors of the engine to be supplied with fuel is held in its bore in the intake manifold module or in the cylinder head module by a hold down made of plastic, the hold down releasing the cross section of flow of the fuel line between the individual injectors.

The individual injectors of an internal combustion engine are secured in the particular bores by the plastic hold downs, and in addition, the hold downs accommodate the contacting cable by way of which the individual injectors are triggered. The contacting cables for triggering the individual injectors are connected to contacts which in turn pass through wall sections of the hold downs that are configured in segments. The wall sections of the hold downs configured in segments delimit an opening which allows the passage of fuel from one injector to the next; furthermore, the contacts run in the segment-like wall sections of the hold down up to the end face of the segment-like wall sections of the hold downs. The contacts there are connected to contacts which are encapsulated in a disk situated above the upper end face of the particular injector.

The head area of the hold down, which may be connected to the surface of an intake manifold module or a cylinder head module, is used to guide the contacting cable in parallel to the fuel line through the intake manifold module or the cylinder head module of an engine. Circuit boards or printed circuits and the channels surrounding them may be omitted. The plastic hold downs may be joined to the top side of the intake manifold/cylinder head module, if made of plastic, by a joining method (ultrasonic welding) which produces a bonded connection. However, if the intake manifold/cylinder head module is made of aluminum, the hold downs may be attached to the intake manifold/cylinder head module of the engine by a screw connection and a sealing ring.

Providing an open part in the direction of fuel flow between the segment-like wall sections as well as parallel to the receiving bore for the injector in the intake manifold/cylinder head module allows a fuel supply to the particular injector provided beneath the hold down as well as the additional injectors connected downstream from this one in series.

### DRAWING

The present invention is explained in greater detail below on the basis of the drawing.

FIG. 1 shows an injector integrated into an intake manifold having a hold down and a contact in a longitudinal section;

FIG. 2 shows a longitudinal section through an intake manifold with the injector inserted into it;

FIG. 2.1 shows the hold downs inserted into the bores in the intake manifold, the contacts guided in the heads of the hold downs, and

FIG. 2.2 shows a view of a hold down from beneath.

### VARIANTS OF AN EMBODIMENT

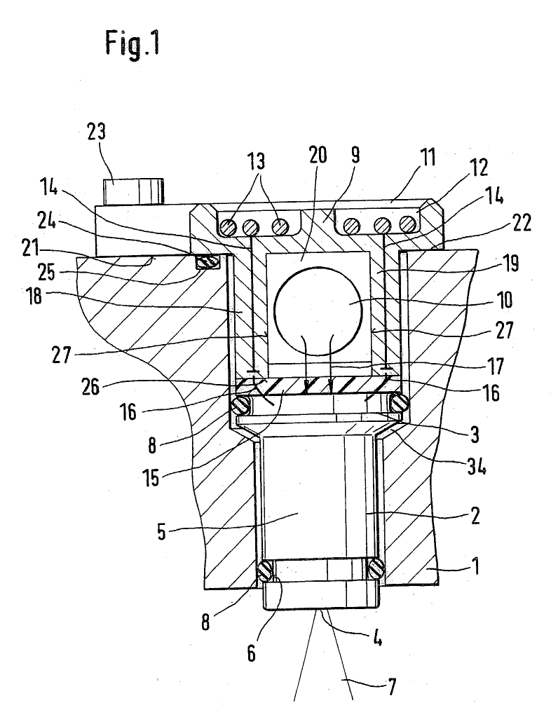

FIG. 1 shows an injector integrated into an intake manifold having a hold down and a contact in a longitudinal section.

Injector 2 is inserted into a receptacle 34 of a receiving body 1. Receiving body 1 may be an intake manifold, an intake manifold module or a cylinder head. Receiving body 1 may be designed as an aluminum intake manifold or an aluminum intake manifold module or as an aluminum cylinder head or an aluminum cylinder head module.

Injector 2 is accommodated in a receptacle 34, which is preferably designed as a bore. Injector 2 is centered in receptacle 34 by O-rings 8, one of which is accommodated above head face 3 of injector 2, while the other O-ring 8 is inserted into a ring groove 6 of injector 2. Injector 2 is centered and sealed by lower O-ring 8, which is inserted into ring groove 6, and upper O-ring 8, which is provided for head face 3. Reference number 5 denotes a bore (not shown in detail here) through which fuel passes through injector 2 and in the form of an injection cone 7 enters the intake component of an internal combustion engine at an injection opening 4.

A plastic sheathing 15 which accommodates encapsulated contacts 16 is provided above injector 2 inserted into receiving bore 34. Opposite encapsulated contacts 16 there is a hold down 9, which projects into the upper area of receptacle 34.

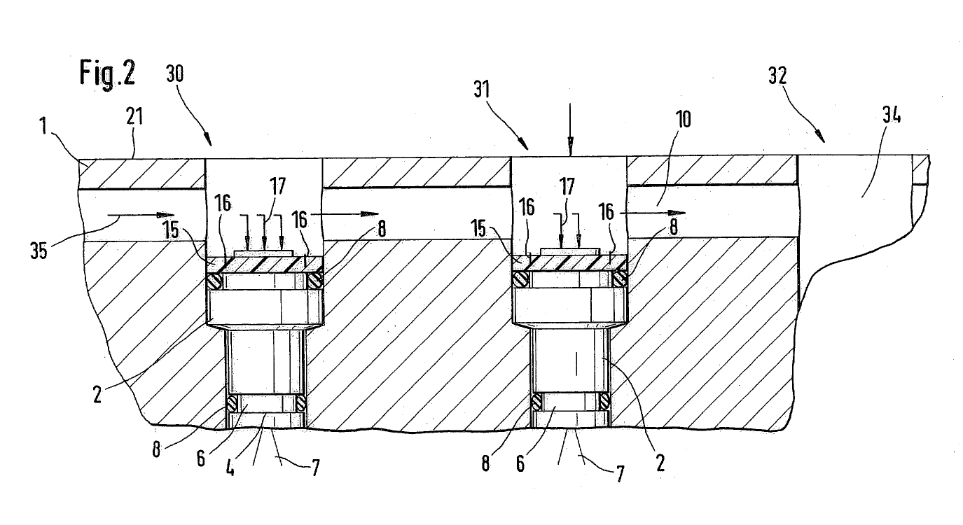

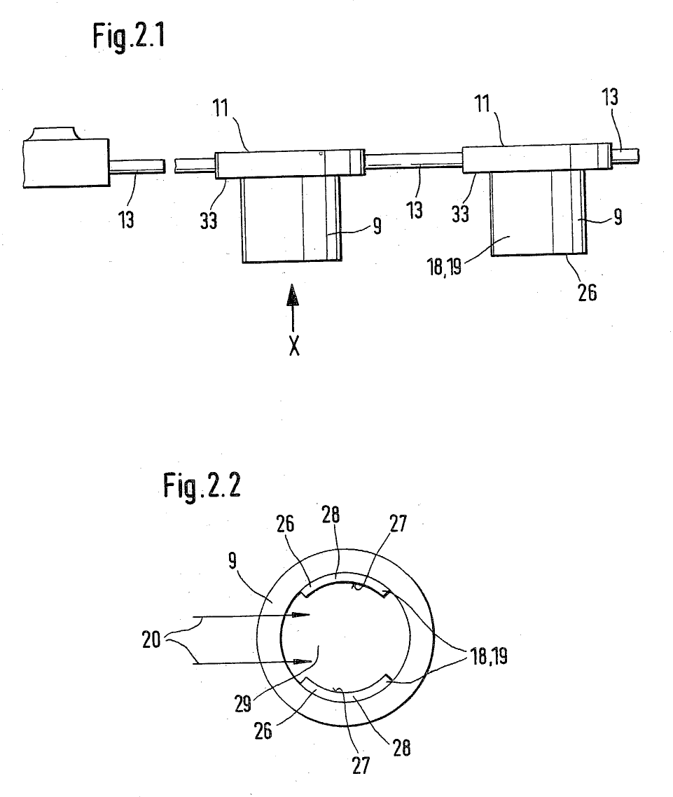

In the diagram according to FIG. 1, which shows a cross section through a receiving body 1 perpendicular to fuel line 10, hold down 9 is also shown in cross section. Hold down 9, which may be designed in its head area as a plastic rail extending perpendicular to the plane of the drawing according to FIG. 1, contains individual segment-like wall sections 18 and/or 19 projecting into receptacle 34 in receiving body 1. These wall sections are designed as opposing webs and leave free an opening 20, which corresponds to the diameter of fuel line 10, between their particular inside walls 27 (see FIG. 2.2). Cavities 12 are formed in the upper area of hold down 9, extending perpendicular to the plane of the drawing according to FIG. 1, and contacting cables 13 which are guided in the receiving body in parallel with fuel line 10 are accommodated in these cavities. According to the diagram in FIG. 1, six contacting cables 13 are accommodated in cavities 12, of which the diagram in FIG. 1 shows only the middle cables of contacting cables 13 connecting contacts 14 passing through segment-like wall sections 18 and/or 19. Contacts 14 pass through segment-like wall sections 18, 19 of the hold down in the area of receptacle bore 34 and end at its lower segmented foot surfaces 26, where they come in contact with contacts 16 cast in plastic sheathing 15, these contacts being used to trigger injector 2 which is inserted into the lower area of receptacle bore 34 and centered there.

Cavity 12 in the upper area of hold down 9, i.e., the area of the plastic rail extending perpendicular to the plane of the drawing, is sealed by a hold-down cover 11, for example, which may be friction-welded.

According to the diagram in FIG. 1, various possibilities for connecting hold down 9, which is designed as a plastic rail, to receiving body 1 are shown.

If the plastic rail, preferably extending perpendicular to the plane of the drawing according to FIG. 1 and accommodating hold down 9, is inserted into a receiving body 1 made of plastic, either an intake manifold or an intake manifold module, a bonded connection may be formed by ultrasonic welding between a lower side 33 of hold down 9 and a flat face 21 of receiving body 1. A seal is provided directly by the weld, so that no additional sealing elements need be used in this joining method.

If the plastic rail on which individual hold downs 9 are accommodated is mounted on an intake manifold or an intake manifold module made of aluminum or an aluminum cylinder head, then a screw connection 23 with which the plastic rail accommodating hold down 9 may be screwed onto flat face 21 of receiving body 1 is used to accommodate the plastic rail. According to this assembly variant, a groove 25 is provided in flat face 21 of receiving body 1 in the area of receptacle 34 of injector 2 and hold down 9 in receiving body 1. A sealing ring 24 is placed in groove 25, so that the imperviousness of an arrangement according to this mounting variant may be ensured.

Injectors 2 are held in receiving bore 34 in receiving body I by hold down 9, which extends as a plastic rail perpendicular to the plane of the drawing according to FIG. 1, so that recoil forces which occur in the injection operation and act on the body of injector 2 may be absorbed. To improve the sealing and of injector 2, it is accommodated in two O-rings 8 in receiving bore 34; furthermore, hold down 9 extending perpendicular to the plane of the drawing is either attached to the top side of a flat face 21 of the receiving body by a bonding method or is connected by a screw to a metallic receiving body 1 with a sealing element 24 in between, inserted into a groove in flat surface 21.

The longitudinal section through an intake manifold having injectors inserted into it is shown in the drawing according to FIG. 2.

In the partially sectional view according to FIG. 2, hold downs 9 designed on a plastic rail in FIG. 2.1 have been removed from receiving bores 34 for injectors 2 in receiving body 1. A plastic sheathing 15 is shown above injector 2, which is inserted into receiving body 1 of the intake manifold or the intake manifold module or the cylinder head module by using two O-rings 8. This shows encapsulated contacts 16, which are connected to contacts 14 passing through segment-like wall sections 18 and/or 19 of hold down 9. The adjusting fuel flow to the fuel bore (not shown in detail here) through injector 2 is labeled as 17; a fuel injection, symbolized by an injection cone 7, is performed through this injector at injection opening 4.

Individual injectors 2 in receiving body 1 may be accommodated one after the other in series, as illustrated in FIG. 2, and may be joined together by a common fuel line 10. In fuel line 10, fuel flows in the direction of flow 35, so that a continuous supply of fuel to all injectors 2 through a fuel flow 17 is ensured. To ensure fuel flow 17 to the individual injectors, hold downs 9, which are interconnected on a plastic rail, are provided with two segment-like wall sections 18 and 19 in opposition to one another. This is best seen in the diagram according to FIG. 2.2. The opposing, slightly curved segment-like wall sections 18 and 19 on hold down 9 leave a through-flow opening 20 free between their particular inside walls 27. This through-flow opening 20 corresponds in cross section to the flow cross section for fuel in fuel line 10 so that fuel flow 10 may be conveyed in the direction of flow 35 from one injector to the next with virtually no flow resistance.

Contact faces 28 are formed on the individual slightly curved segment-like wall sections 18 and/or 19 which are provided on hold down 9, of which segment footing 26 are visible according to FIG. 2.2. Contacts 14 of segment-like wall sections 18 and/or 19 are connected via contact faces 28 on the segment-like wall sections to contacts 16 encased in plastic sheathing 15 above head face 3 of injector 2 for triggering the injector.

To achieve flow with minimal flow resistance and without turbulence in the fuel, individual segment-like wall sections 18 and/or 19 on the hold down may be designed with rounded edges. In addition, an open part 29 is provided in hold down 9, ensuring that fuel entering through-flow opening 20 according to reference number 17 (see FIG. 2) is supplied continuously to the inflow bore of injector 2.

A series arrangement of injectors in a receiving body 1 is shown in the diagram according to FIG. 2. A first injector 30 is also supplied with fuel through fuel line 10 in direction of flow 35, as is a second injector 32 and another injector 32 (not shown in detail here), of which only receiving bore 34 may be seen.

The diagram according to FIG. 2.1 shows a side view of hold-down arrangement 9, which is designed essentially as a plastic rail. Individual hold downs 9 on the plastic rail have ring-shaped surfaces 33 which are the faces by which individual hold downs are connected to flat face 21 of receiving body 1 by a joining method, which is mentioned in conjunction with FIG. 1 and depends on the material. Reference number 13 denotes the individual contacting cables which are accommodated in the plastic rail and join the individual hold-down heads together.

FIG. 2.2 shows hold downs 9 in a view according to arrow X. The hold down is positionable on plastic part 15 designed in receiving bore 34 in receiving body 1 via segment footing 26, which extend in an approximately sickle shape on hold down 19. Inside faces 27 are in contact with the ring-shaped face between encapsulated contacts 16 (see diagram according to FIG. 2) and align hold down 9 with respect to receiving bore 34 in receiving body 1.

### List of Reference Notation

1 Receiving body

2 Injector

3 Head face

4 Injection opening

5 Inlet bore

6 Ring groove

7 Injection cone

8 O-ring

9 Hold down

10 Fuel line

11 Hold-down cover

12 Cable cavity

13 Contacting cable

14 Contact

15 Plastic sheathing

16 Encapsulated contacts

17 Fuel flow

18 First hold-down segment

19 Second hold-down segment

20 Through-flow opening

21 Flat face

22 Bonded connection

23 Fastening screw

24 Sealing ring

25 Groove in flat face 21

26 Segment foot face 18, 19

27 Inside walls [of] segments 18, 19

28 Contact face

29 Open part

30 First injector

31 Second injector

32 Additional injector

33 Ring face

34 Receiving bore

35 Direction of flow of fuel in fuel line 10

What is claimed is:

1. A device for supplying fuel to combustion chambers of an internal combustion engine, comprising an injector (2) which is accommodated in a receptacle (34) of a receiving body (1) and is supplied with fuel through a fuel line (10) and which is triggered via contact elements (13, 14, 16),
wherein the injector (2) is positioned in the receiving body (1) by using a hold down (9) having areas (12, 18, 19) for receiving contact elements (13, 14, 16).

2. The device as recited in claim 1,
wherein the injector (2) is centered in the receptacle (34) in the receiving body (1) by using flexible sealing elements (8).

3. The device as recited in claim 1,
wherein the receiving body (1) is an intake manifold or an intake manifold module made of plastic.

4. The device as recited in claim 1,
wherein the receiving body (1) is designed as an intake manifold/intake manifold module or a cylinder head/cylinder head module made of cast aluminum.

5. The device as recited in claim 1,
wherein the hold down (9) is designed as a plastic rail which extends parallel to the positioning of the injectors (2) in the receiving body (1).

6. The device as recited in claim 5,
wherein the plastic rail of the hold downs (9) is provided with segment-like wall sections (18, 19) which are insertable into the receptacles (34) for the injectors (2).

7. The device as recited in claim 5,
wherein the contacting cables (13), which are electrically connected to contacts (14), are guided in an upper cavity (12) in the plastic rail of the hold downs (9).

8. The device as recited in claim 5,
wherein the segment-like wall sections (18, 19) the hold downs (9) project into the fuel line (10), so that a flow channel (20) is formed for fuel for the downstream injector (2).

9. The device as recited in claim 1,
wherein the fuel line (10) is integrated into the receiving body (1).

10. The device as recited in claim 5,
wherein the contacts (14) accommodated in the segment-like wall sections (18, 19) of the hold downs (9) are connected to contacts (16) at the footing (26), these contacts being located above a plastic sheathing (15) of the injector (2) in the receiving body (1).

11. The device as recited in claim 1,
wherein a detachable connection sealed by a sealing ring (24) is formed between a receiving body (1) made of aluminum and the plastic rail which accommodates the hold downs (9).

12. The device as recited in claim 1,
wherein the hold down (9) are integrally joined at a ring face (33) to a flat face (21) of the receiving body (1) by an ultrasonic welding method.
